(19) United States
(12) Patent Application Publication
(10) Pub. No.: US 2019/0132184 A1
(43) Pub. Date: May 2, 2019

(54) Connecting Module

(71) Applicant: Wistron Corporation, New Taipei City (TW)

(72) Inventor: Tsung-Hsiang Shyu, New Taipei City (TW)

(21) Appl. No.: 15/871,077

(22) Filed: Jan. 15, 2018

(30) Foreign Application Priority Data
Oct. 30, 2017 (TW) 106137396

(51) Int. Cl. H04L 29/06

(52) U.S. Cl. CPC H04L 29/06088

(57) ABSTRACT

A connecting module, for connecting an accelerating device to a first server system or a second server system to transmit a digital signal, includes a first communication unit, for connecting the accelerating device and the first server system to transmit the digital signal; a second communication unit, for connecting the accelerating device and the second server system to transmit the digital signal; and a processing unit, coupled to the first communication unit and the second communication unit, for instructing at least one connector of the accelerating device to be coupled to each other through the first communication unit when the first communication unit connects to the accelerating device and the first server system, or instructing the second communication unit coupled to the at least one connector of the accelerating device when the second communication unit connects to the accelerating device and the second server system.

### BACKGROUND OF THE INVENTION

### 1. Field of the Invention

The present disclosure relates to a connecting module, and more particularly, to a connecting module capable of connecting an accelerating device to server systems of different processor architectures.

### 2. Description of the Prior Art

With the development of artificial intelligence (AI), big data, cloud computing, etc., the server system with high computation speed has become one of the primary developing objectives in the field. In order to obtain high computation speed, utilizing the external graphics processing unit (GPU) connected to the server system for performing the accelerating operation has become one of the most effective approaches to accelerate the server system. Notably, in the prior art, the server system may have different data transmission speeds and different hardware interfaces according to different signal standards. The accelerating device may only be connected to the corresponding server system which has the compatible hardware interface to the accelerating device.

Furthermore, the server system may be categorized to the x86 processor architecture and the PowerPC processor architecture, wherein these two architectures are different in the communication protocol, the connecting hardware interface and data transmission speed. The x86 processor architecture transmits data through the peripheral component interconnect express (PCI Express, PCI-e) standard and the PowerPC processor architecture transmits data through the NVLink standard. For the differences in the connecting hardware interfaces of the x86 processor architecture and the PowerPC processor architecture, the accelerating device may only be selectively connected to the x86 processor architecture with the PCI-e standard or to the PowerPC processor architecture with the NVLink standard. Therefore, the accelerating device cannot connect to the serve system which has incompatible the communication protocol and the hardware interface. In order to improve the compatibility to the server systems of different processor architectures, the prior art has to be improved.

### SUMMARY OF THE INVENTION

It is therefore a primary objective of the present disclosure to provide a connecting module capable of connecting the accelerating device to the server systems of different processor architectures, so as to improve the system compatibility of the accelerating device.

The present disclosure provides a connecting module, for connecting an accelerating device to a first server system or a second server system to transmit a digital signal. The connecting module includes a first communication unit, for connecting the accelerating device and the first server system to transmit the digital signal; a second communication unit, for connecting the accelerating device and the second server system to transmit the digital signal; and a processing unit, coupled to the first communication unit and the second communication unit, for instructing at least one connector of the accelerating device to be coupled to each other through the first communication unit when the first communication unit connects to the accelerating device and the first server system, or instructing the second communication unit coupled to the at least one connector of the accelerating device when the second communication unit connects to the accelerating device and the second server system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a connecting module according to an embodiment of the present disclosure.

FIG. 2 is a schematic diagram of a connecting module connected to an accelerating device and a first server system according to an embodiment of the present disclosure.

FIG. 3 is a schematic diagram of the connecting module connected to an accelerating device and a second server system according to an embodiment of the present disclosure.

FIG. 4 is a schematic diagram of a connecting system according to an embodiment of the present disclosure.

### DETAILED DESCRIPTION

In general, an accelerating device is externally connected to the server system to perform the accelerating operation. The accelerating device should be connected to the server system of the compatible signal standard or the hardware interface. Therefore, for the limitations of the connection between the accelerating device and the server system, the accelerating device in the prior art may be utilized for only connecting to the server system of a certain signal standard and may not be utilized for connecting to the server systems of other signal standards. Under such a circumstance, the present disclosure provides a connecting module, which is capable of connecting the accelerating device to the server systems of different processor architectures so as to improve the system compatibility of the accelerating device to different server systems.

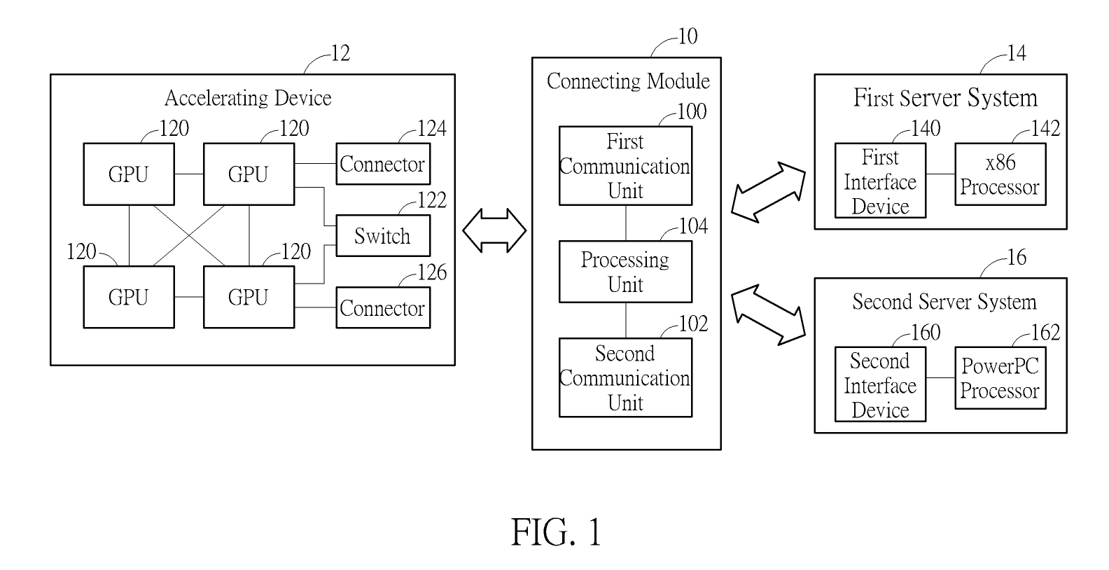

Please refer to FIG. 1, which is a schematic diagram of a connecting module 10 according to an embodiment of the present disclosure. The connecting module 10 is capable of connecting an accelerating device 12 to a first server system 14 or a second server system 16. Notably, the first server system 14 and the second server system 16 are the server systems of different processor architectures, which are different in signal standards and hardware interfaces. The accelerating device 12 is able to receive the digital signal delivered by the first server system 14 or the second server system 16 through the connecting module 10. After the accelerating operation is performed by the accelerating device 12, the computation result is delivered to the first server system 14 or the second server system 16 through the connecting module 10 so as to accelerate the first server system 14 or the second server system 16.

The connecting module 10 includes a first communication unit 100, a second communication unit 102 and a processing unit 104. The first communication unit 100 is utilized for connecting the first server system 14. The second communication unit 102 is utilized for connecting the second server system 16. In this embodiment, the first server system 14 is a server system of an x86 processor architecture. Therefore, the first server system 14 and the first communication unit 100 may be utilized for delivering the digital signal of the PCI Express (PCI-e) standard. The second server system 16 is a server system of a PowerPC processor architecture. Therefore, the second server system 16 and the second communication unit 102 maybe utilized for delivering the digital signal of the NVLink standard. Furthermore, the digital signal of the PCI-e standard is delivered through a single signal path, and the first communication unit 100 is able to deliver the digital signal to the accelerating device 12 and the first server system 14 through a single connector. The digital signal of the NVLink standard is delivered through dual connectors, and the second communication unit 102 is able to deliver the digital signal to the accelerating device 12 and the second server system 16 through the dual connectors. Under such a circumstance, the processing unit 104 is coupled to the first communication unit 100 and the second communication unit 102, utilized for instructing the accelerating device 12 to deliver the digital signal corresponding to the PCI-e standard through the first communication unit 100 when the first communication unit 100 is connected to the accelerating device 12 and the first server system 14, or instructing the accelerating device 12 to deliver the digital signal corresponding to the NVLink standard through the second communication unit 102 when the second communication unit 102 is connected to the accelerating device 12 and the second server system 16, such that the accelerating device 12 is compatible to the PCI-e standard and the NVLink standard.

In other words, the connecting module 10 of the present disclosure may be connected between the accelerating device 12 and the first server system 14 or the second server system 16 to connect the accelerating device 12 to the server systems of different processor architectures, so as to integrate the accelerating device 12 to different server systems and improve the system compatibility of the accelerating device 12.

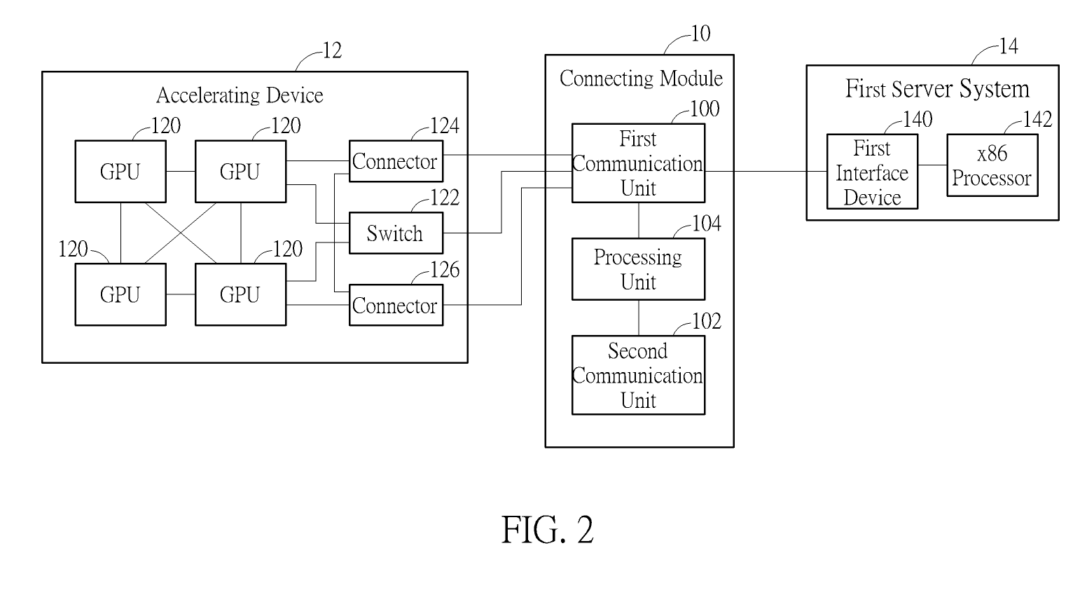

In detail, please refer to FIG. 2, which is a schematic diagram of the connecting module 10 connected to the accelerating device 12 and the first server system 14 according to an embodiment of the present disclosure. In this embodiment, the first server system 14 is the server system of the x86 processor architecture. Therefore, the first server system 14 receives and delivers the digital signal of the PCI-e standard. In detail, the first server system 14 includes a first interface device 140 and an x86 processor 142. The x86 processor 142 is utilized for processing the system operations of the server system 14 and generating the digital signal to the accelerating device 12 so as to perform the accelerating operation. The first interface device 140 delivers the digital signal of the PCI-e standard generated by the x86 processor 142 to the accelerating device 12 through the connecting module 10, and the connecting module 10 receives the computation result generated by the accelerating device 12 through the connecting module 10. The accelerating device 12 includes a plurality of graphics processing units (GPU) 120, a switch 122, a connector 124 and a connector 126. The graphics processing units 120 are utilized for receiving the digital signal to perform the accelerating operation so as to generate the computation result. Each graphics processing unit 120 is connected through the NVLink standard and the computation speed of the accelerating device 12 may be elevated according to the interconnections of the graphics processing units 120. The switch 122 is coupled to the graphics processing unit 120, utilized for delivering the digital signal of the PCI-e standard to the graphics processing units 120 or receiving the digital signal of the PCI-e standard generated by the graphics processing unit 120. The connector 124 and the connector 126 are coupled to the graphics processing units 120, utilized for delivering the digital signal of the NVLink standard to the graphics processing unit 120 or receiving the digital signal of the NVLink communication generated by the graphics processing unit 120.

In detail, when the connecting module 10 is connected to the accelerating device 12 and the first server system 14, the connecting module 10 may deliver the digital signal of the PCI-e standard. Therefore, a signal path is formed by the connection between the first interface device 140, the connecting module 10 and the first communication unit 100 of the first server system 14 and the switch 122 of the accelerating device 12, wherein the signal path is utilized for delivering the digital signal of the PCI-e standard. In addition, the processing unit 104 may instruct the connector 124 and the connector 126 of the accelerating device 12 through the first communication unit 100 when the first communication unit 100 is connected to the accelerating device 12 and the first server system 14, such that the connector 124 and the connector 126 connect to each other and generate a connection relationship corresponding to the PCI-e standard. Therefore, when the accelerating device 12 is connected to the first server system 14 through the connecting module 10, the connector 124 and the connector 126 may connect to each other to form the signal path and deliver the computation result generated by the accelerating device 12. In other words, when the connecting module 10 is connected to the accelerating device 12 and the first server system 14 of the x86 processor architecture, the connecting module 10 may deliver the digital signal of the PCI-e standard to the accelerating device 12 and the first server system 14 through the first communication unit 100. In addition, through the connection relationship corresponding to the PCI-e standard instructed by the processing unit 104, the first server system 14 is able to deliver the digital signal to the accelerating device 12 and perform the accelerating operation.

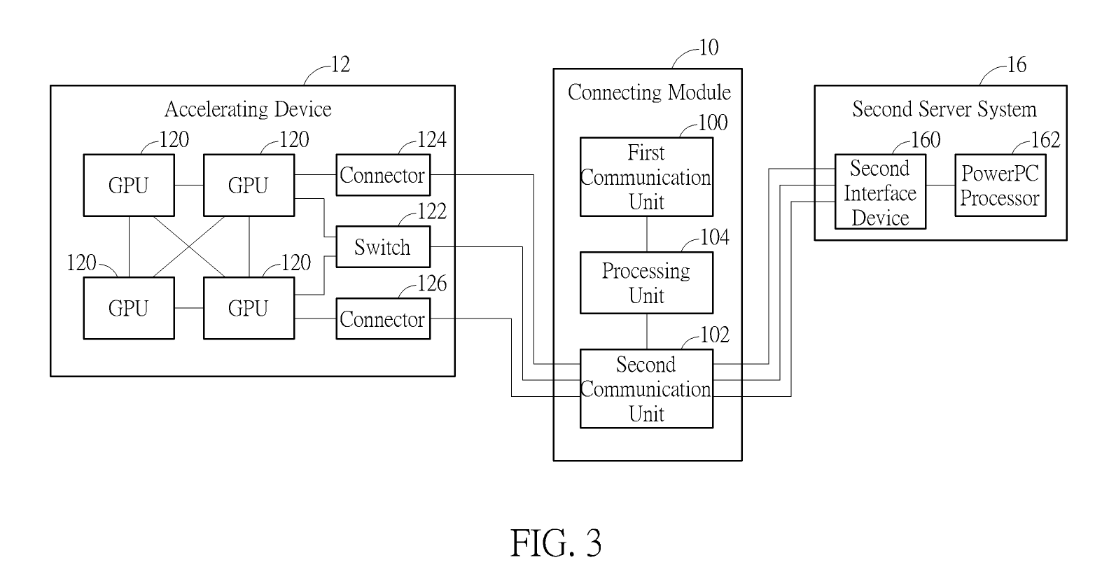

In addition, please refer to FIG. 3, which is a schematic diagram of the connecting module 10 connected to the accelerating device 12 and the second server system 16 according to an embodiment of the present disclosure. Notably, in this embodiment, the second server system 16 is the server system of the PowerPC processor architecture. Therefore, the second server system 16 receives or delivers the digital signal of the PCI-e standard. In detail, as shown in FIG. 3, the second server system 16 includes a second interface device 160 and a PowerPC processor 162. The PowerPC processor 162 is utilized for processing the system operations of the server system 16 and generating the digital signal to the accelerating device 12 so as to perform the accelerating operation. The second interface device 160 delivers the digital signal of the NVLink standard generated by the PowerPC processor 162 to the accelerating device 12 through the connecting module 10, and the second interface device 160 receives the computation result generated by the accelerating device 12 through the connecting module 10.

In detail, when the connecting module 10 is connected to the accelerating device 12 and the second server system 16, the connecting module 10 may deliver the digital signal of the PCI-e standard and the NVLink standard. Under such a circumstance, a first signal path is formed by the connection between the second interface device 160 of the server system 16, the second communication unit 102 of the connecting module 10 and the switch 122 of the accelerating device 12, wherein the first signal path is utilized for delivering the digital signal of the PCI-e standard. In addition, a second signal path is formed by the connection between the second interface device 160 of the server system 16, the second communication unit 102 of the connecting module 10, the connector 124 and the connector 126 of the accelerating device 12, wherein the second signal path is utilized for delivering the digital signal of the NVLink standard. Therefore, the processing unit 104 may instruct the connector 124 and the connector 126 of the accelerating device 12 through the second communication unit 102 when the second communication unit 102 is connected to the accelerating device 12 and the second server system 16, such that the connector 124 and the connector 126 are connected to the second communication unit 102 and generate a connection relationship corresponding to the NVLink standard. Therefore, when the accelerating device 12 is connected to the second server system 16, the second signal path is formed by the connection between the connector 124, the connector 126, the second communication unit 102 and the second interface device 160, such that the second signal path conforms to the NVLink standard and delivers the computation result generated by the accelerating device 12. For the first signal path and the second signal path delivering the digital signals of the different transmission speeds, the second communication unit 102 may further compare the transmission speeds of the first signal path and the second signal path and choose a signal path which has a faster transmission speed for delivering the digital signal so as to elevate the transmission speed of the system. In other words, when the connecting module 10 is connected to the accelerating device 12 and the second server system 16 of the PowerPC processor architecture, the connecting module 10 may deliver the digital signal of the PCI-e standard through the first signal path generated by the second communication unit 102, and deliver the digital signal of the NVLink standard through the second signal path generated by the second communication unit 102. Under such a circumstance, the accelerating device 12 and the second server system 16 are connected by the first signal path and the second signal path, wherein the second communication unit 102 chooses the signal path which has the faster transmission speed so as to elevate the transmission speed of the second server system 16.

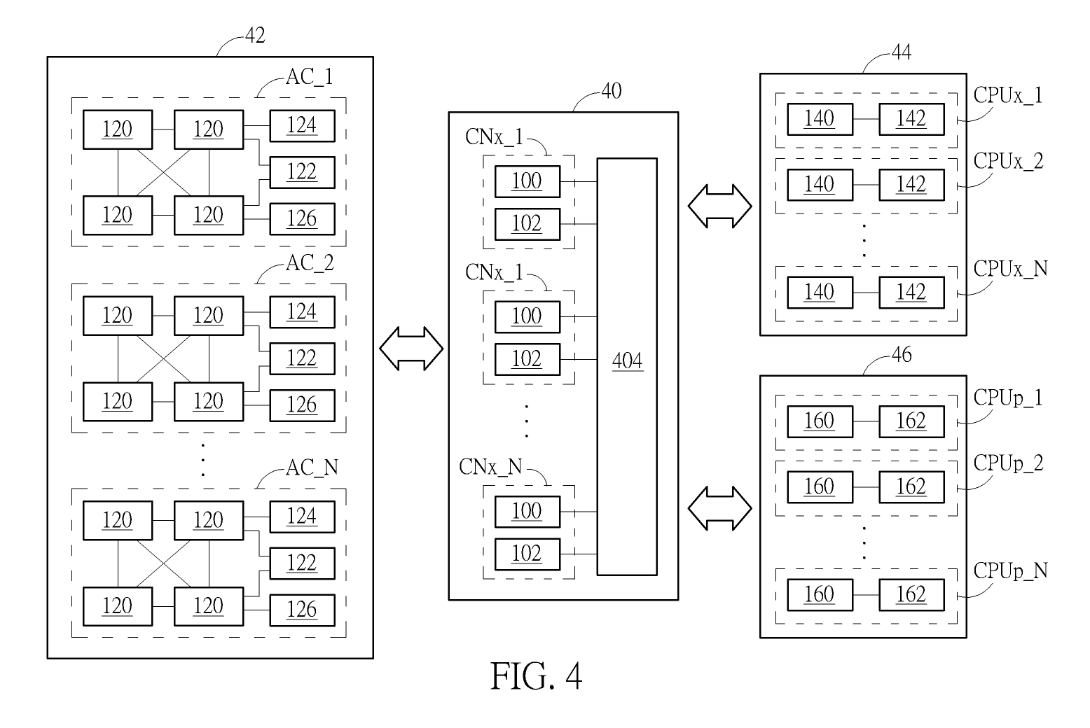

Notably, the embodiments stated in the above are utilized for illustrating the concept of the present disclosure. Those skilled in the art may make modifications and alterations accordingly, and not limited herein. For example, please refer to FIG. 4, which is a schematic diagram of a connecting system 40 according to an embodiment of the present disclosure. The connecting system 40 is capable of connecting an accelerating system 42 to a first server system 44 or a second server system 46. The connecting system 40 is derived from the connecting module 10, and the same components are denoted by the same symbols for simplicity. The connecting system 40 is applied for the multi-core processor architecture. In other words, the first server system 44 and the second server system 46 are server systems of multi-core processor architectures. In detail, the first server system 44 includes a plurality of first server subsystems CPUx_1-CPUx_N, and each of the first server subsystems CPUx_1-CPUx_N is the first server system 14 in FIG. 1, wherein each of the first server subsystems CPUx_1-CPUx_N respectively includes the first interface device 140 and the x86 processor 142. Similarly, the second server system 46 includes a plurality of second server subsystems CPUp_1-CPUp_N, and each of the second server subsystems CPUp_1-CPUp_N is the second server system 16 in FIG. 1, wherein each of the second server subsystems CPUp_1-CPUp_N respectively includes the second interface device 160 and the PowerPC processor 162. Therefore, the connecting system 40 includes a plurality of connecting modules CNx_1-CNx_N corresponding to the amount of the processor, and each of the connecting modules CNx_1-CNx_N includes the first communication unit 100 and the second communication unit 102. According to the connecting modules CNx_1-CNx_N of the connecting system 40, the digital signal generated by the first server system 44 or the second server system 46 may be delivered to a plurality of accelerating devices ACV_1-AC_N of the accelerating system 42. Therefore, according to the connecting system 40 of the present disclosure, the accelerating system 42 may be connected to the first server system 44 or the second server system 46, such that the accelerating system 42 is compatible to the multi-core processor architecture to perform the accelerating operation.

In addition, as shown in FIG. 4, the connecting system 40 integrates the operation of the connecting modules CNx_1-CNx_N by the single processing unit 404, wherein the processing unit 404 is coupled to the first communication units 100 and the second communication units 102, utilized for instructing the connector 124 of the accelerating system 42 to generate the connection relationship corresponding to the signal standard through the first communication unit 100 or the second communication unit 102, such that the accelerating system 42 is compatible to the first server system 44 or the second server system 46. However, the connecting system 40 may also include a plurality of processing units to respectively process the digital signal corresponding to each connecting module as the process performed by the connecting module 10 shown in FIG. 1, which is also within the scope of the present disclosure and is not limited herein.

In the prior art, the external accelerating device may be selectively connected to a compatible server system according to the signal standard, and the accelerating device may not be connected to the server systems of the different signal standards. In comparison, the connecting module of the present disclosure may connect the accelerating device to the server systems of different processor architectures, so as to improve the system compatibility of the accelerating device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connecting module, for connecting an accelerating device to a first server system or a second server system to transmit a digital signal, the connecting module comprising:
a first communication unit, for connecting the accelerating device and the first server system to transmit the digital signal;
a second communication unit, for connecting the accelerating device and the second server system to transmit the digital signal; and
a processing unit, coupled to the first communication unit and the second communication unit, for instructing at least one connector of the accelerating device to be coupled to each other through the first communication unit when the first communication unit connects to the accelerating device and the first server system, or instructing the second communication unit coupled to the at least one connector of the accelerating device when the second communication unit connects to the accelerating device and the second server system.

2. The connecting module of claim 1, wherein the first server system is a server system of an x86 processor architecture.

3. The connecting module of claim 2, wherein the first communication unit transmits the digital signal to the accelerating device and the first server system through a peripheral component interconnect express standard (PCI Express, PCI-e).

4. The connecting module of claim 2, wherein the first communication unit connects to a switch of the accelerating device and the first server system so as to exchange the digital signal between the accelerating device and the first server system.

5. The connecting module of claim 1, wherein the second server system is a server system of a PowerPC processor architecture.

6. The connecting module of claim 5, wherein the second communication unit connects to the switch of the accelerating device and the second server system through a peripheral component interconnect express standard (PCI Express, PCI-e) standard to generate a first signal path, and connects to the at least one connector of the accelerating device and the second server system through an NVLink standard to generate a second signal path.

7. The connecting module of claim 6, wherein the second communication unit is further utilized for comparing transmission speeds of the first signal path and the second signal path, and choosing a signal path which has a faster transmission speed from the first signal path and the second signal path to transmit the digital signal.

8. The connecting module of claim 1, wherein the first server system or the second server system transmits the digital signal to the accelerating device through the connecting module to generate a calculation result, and to transmit the calculation result to the first server system or the second server system.
